(19) United States
(12) Patent Application Publication
(10) Pub. No.: US 2025/0131439 A1
(43) Pub. Date: Apr. 24, 2025

(54) SYSTEMS AND METHODS FOR FRAUD REDUCTION THROUGH MULTI-BUSINESS AUTHENTICATION

(71) Applicant: Capital One Services, LLC, McLean, VA (US)

(72) Inventors: Jeffrey RULE, Chevy Chase, MD (US); Lawrence DOUGLAS, McLean, VA (US); Jackson MACOMBER, Henrico, VA (US)

(73) Assignee: Capital One Services, LLC, McLean, VA (US)

(21) Appl. No.: 18/917,248

(22) Filed: Oct. 16, 2024

Related U.S. Application Data
(60) Provisional application No. 63/544,905, filed on Oct. 19, 2023.

(51) Int. Cl. G06Q 20/40

(52) U.S. Cl. CPC G06Q 20/4016

(57) ABSTRACT

A method for reducing fraud comprises receiving, by a server from a merchant device associated with a merchant, a first plurality of risk data associated with a user, receiving, by the server from a software development kit embedded by a first entity, a second plurality of risk data associated with the user, and receiving, by the server from a second entity, a third plurality of risk data associated with the user. The method further comprises identifying the user, training, by the server, a fraud risk machine learning model, and determining, by the server, a fraud risk profile of the user, based on the fraud risk machine learning model, using the first plurality of risk data, the second plurality of risk data, and the third plurality of risk data.

### CROSS-REFERENCE TO RELATED APPLICATION

This application claims the priority of U.S. Provisional Patent Application No. 63/544,905, filed on Oct. 19, 2023, the contents of which are incorporated herein by reference in their entirety.

### FIELD OF THE INVENTION

The present disclosure relates generally to data security, and more particularly, to systems and methods for reducing fraud through cross-business authentication.

### BACKGROUND

Data security and transaction integrity are of critical importance to businesses and consumers. Fraudulent transactions can be very costly and disruptive for businesses and consumers, and attempts by fraudulent actors to perform fraudulent transactions or other fraudulent activity are increasing.

To counter fraud, customers are usually authenticated using multiple factors when transactions are being conducted, however, account takeover attempts have been a constant risk that keeps increasing. Authentication weaknesses, such as vulnerabilities in text authentications, contribute to the risk of fraud. In addition, fraudulent actors can take advantages of the fact that businesses rarely, if ever, share data on previous fraud attempts, which allows fraudulent actors to attempt fraudulent transactions or other fraudulent activity at multiple businesses before they are blocked.

These and other deficiencies exist. Accordingly, there is a need to provide systems and methods that overcome these deficiencies to reduce fraud.

### SUMMARY

Aspects of the disclosed technology include systems and methods of reducing fraud through cross-bank authentication.

Embodiments of the present disclosure provide a method for reducing fraud. The method comprises: receiving, by a server from a merchant device associated with a merchant, a first plurality of risk data associated with a user; receiving, by the server from a software development kit (SDK) embedded by a first entity, a second plurality of risk data associated with the user; receiving, by the server from a second entity, a third plurality of risk data associated with the user; identifying the user; training, by the server, a fraud risk machine learning model; and determining, by the server, a fraud risk profile of the user, based on the fraud risk machine learning model, using the first plurality of risk data, the second plurality of risk data, and the third plurality of risk data.

Embodiments of the present disclosure provide a system for reducing fraud. The system comprises a server comprising a processor and a memory. The server is configured to: receive, from a merchant device associated with a merchant, a first plurality of risk data associated with a user; receive, from an SDK embedded by a first entity, a second plurality of risk data associated with the user; receive, from a second entity, a third plurality of risk data associated with the user; identify the user; train a fraud risk machine learning model; and determine a fraud risk profile of the user, based on the fraud risk machine learning model, using the first plurality of risk data, the second plurality of risk data, and the third plurality of risk data.

Embodiments of the present disclosure provide a non-transitory, computer-readable medium comprising instructions for reducing fraud that, when executed on a computer arrangement, perform actions comprising: receiving, from a merchant device associated with a merchant, a first plurality of risk data associated with a user; receiving, from an SDK embedded by a first entity, a second plurality of risk data associated with the user; receiving, from a second entity, a third plurality of risk data associated with the user; identifying the user; training a fraud risk machine learning model; and determining a fraud risk profile of the user, based on the fraud risk machine learning model, using the first plurality of risk data, the second plurality of risk data, and the third plurality of risk data.

Further features of the disclosed systems and methods, and the advantages offered thereby, are explained in greater detail hereinafter with reference to specific example embodiments illustrated in the accompanying drawings.

### BRIEF DESCRIPTION OF THE DRAWINGS

FIG. 1 is a diagram of a system for reducing fraud according to an example embodiment.

FIG. 2 is a diagram of sequential interactions between components of the system in FIG. 1 according to an example embodiment.

FIG. 3A is a contactless card used for identifying a user according to an example embodiment.

FIG. 3B is a diagram of a contact pad of the contactless card of FIG. 3A according to an example embodiment.

FIG. 4 is a flow chart of a method for reducing fraud according to an example embodiment.

FIG. 5 is a diagram of sequential interactions between components of a system for reducing fraud according to an example embodiment.

FIG. 6 is a flow chart of a method for determining a fraud risk profile according to an example embodiment.

### DETAILED DESCRIPTION OF EXAMPLE EMBODIMENTS

The following description of embodiments provides non-limiting representative examples referencing numerals to particularly describe features and teachings of different aspects of the invention. The embodiments described should be recognized as capable of implementation separately, or in combination, with other embodiments from the description of the embodiments. A person of ordinary skill in the art reviewing the description of embodiments should be able to learn and understand the different described aspects of the invention. The description of embodiments should facilitate understanding of the invention to such an extent that other implementations, not specifically covered but within the knowledge of a person of skill in the art having read the description of embodiments, would be understood to be consistent with an application of the invention.

The described features and teachings of the embodiments may be combined in any suitable manner. A person of ordinary skill in the art will recognize that the embodiments may be practiced without one or more of the specific features and teachings of an embodiment. In other instances, additional features and teachings may be recognized in certain embodiments that may not be present in all embodiments. A person of ordinary skill in the art will understand that the described features and teachings of any embodiment can be interchangeably combined with the features and teachings of any other embodiment.

Example embodiments of the present disclosure provide systems and methods for reducing fraud, such as fraudulent transactions and other fraudulent activities involving businesses, such as banks. The systems and methods disclosed herein can aggregate fraud criteria across a plurality of banks and draw information from integrated or partnering merchants to be able to build up a better fraud profile on customers. The disclosed systems and methods can collect a list of data. The list of data can either be collected from an SDK that the banks have embedded into the checkout flow for the merchants or collected from information that the merchants might be able to provide.

One advantage of having the merchants aggregate data is that the merchants can draw data from the browser website, such as, whether the customers are browsing through different product pages. The SDK can be embedded into websites of the merchants. The list of data can include customer's behavioral data, customer's geolocation, customer's browsing history, customer's mouse movements, customer's base orientation, etc. The customer may have a universal identifier across all of the banks and/or merchants, for example, a social security number (SSN) of the customer, a contactless card identifier associated with a contactless card of the customer. The list of data can be associated with the customer through the universal identifier. The contactless card as an universal identifier can be distributed out across these different banks.

As another advantage, the systems and methods of the present disclosure can check for fraud in an efficient and time-effective manner that does not unduly hinder transactions. In terms of time to perform a fraud check, a time limit of 50 milliseconds may be a goal or a requirement, and the systems and methods of the present disclosure can meet this time limit.

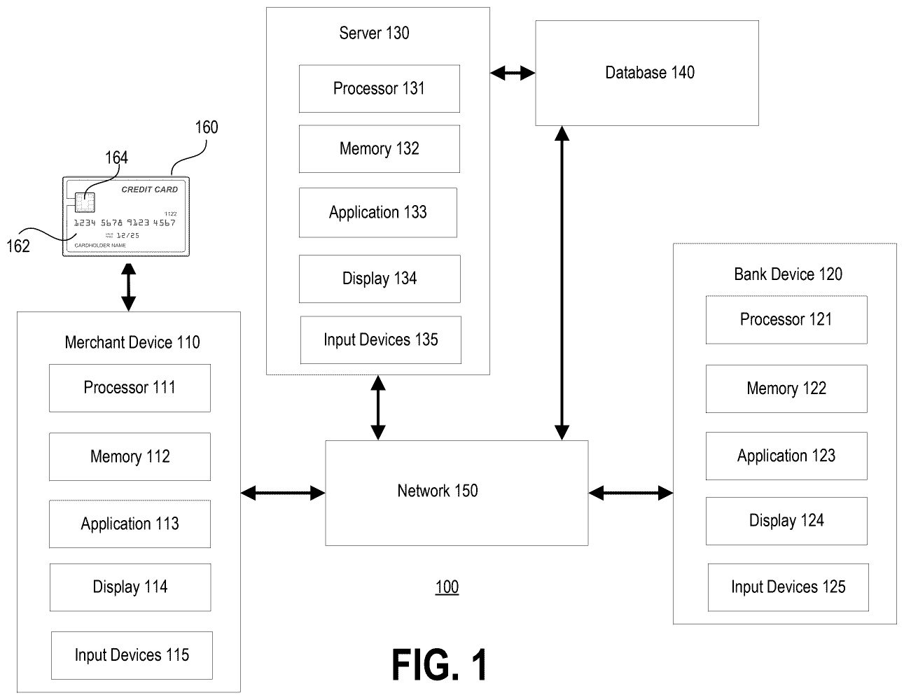

FIG. 1 illustrates a system 100 for reducing fraud according to an example embodiment. As further discussed below, the system 100 may include a merchant device 110, a bank device 120, a server 130, a database 140 in communication using a network 150, and a contactless card 160 in signal communication with the merchant device 110. Although FIG. 1 illustrates single instances of the components, the system 100 may include any number of components.

The merchant device 110 may be associated with a merchant with which transactions are conducted by a user through a user device, for example, online purchases made from the merchant. The merchant device 110 may also be configured to host an online shopping website of the merchant on which users may browse and/or purchase products and/or services provided by the merchant. The merchant device 110 can be configured to store online merchant accounts of users, and to present a shopping interface on which the users can conduct the transactions with the merchant.

The merchant device 110 may be a network-enabled computer device. Exemplary network-enabled computer devices include, without limitation, a server, a network appliance, a personal computer, a workstation, a phone, a handheld personal computer, a personal digital assistant, a thin client, a fat client, an Internet browser, a mobile device, a kiosk, a contactless card, or other a computer device or communications device. For example, network-enabled computer devices may include an iPhone, iPod, iPad from Apple® or any other mobile device running Apple's iOS® operating system, any device running Microsoft's Windows® Mobile operating system, any device running Google's Android® operating system, and/or any other smartphone, tablet, or like wearable mobile device.

The merchant device 110 may include a processor 111, a memory 112, and an application 113. The processor 111 may be a processor, a microprocessor, or other processor, and the first device 110 may include one or more of these processors. The processor 111 may include processing circuitry, which may contain additional components, including additional processors, memories, error and parity/CRC checkers, data encoders, anti-collision algorithms, controllers, command decoders, security primitives and tamper-proofing hardware, as necessary to perform the functions described herein.

The processor 111 may be coupled to the memory 112. The memory 112 may be a read-only memory, write-once read-multiple memory or read/write memory, e.g., RAM, ROM, and EEPROM, and the merchant device 110 may include one or more of these memories. A read-only memory may be factory programmable as read-only or one-time programmable. One-time programmability provides the opportunity to write once then read many times. A write-once read-multiple memory may be programmed at a point in time after the memory chip has left the factory. Once the memory is programmed, it may not be rewritten, but it may be read many times. A read/write memory may be programmed and re-programed many times after leaving the factory. It may also be read many times. The memory 112 may be configured to store one or more software applications, such as the application 113, and other data, such as user's shopping and financial account information.

The application 113 may comprise one or more software applications comprising instructions for execution on the merchant device 110. In some examples, the merchant device 110 may execute one or more applications, such as software applications, that, for example, enable network communications with one or more components of the system 100, transmit and/or receive data, and perform the functions described herein. Upon execution by the processor 111, the application 113 may provide the functions described in this specification, specifically to execute and perform the steps and functions in the process flows described herein. For example, the application 113 may be executed to perform authenticating a user or send an authentication request of authenticating the user to the server 130. The application 113 may also be executed to perform processing transactions of a user who may shop online from the merchant and/or collecting user risk data of the user. Such processes may be implemented in software, such as software modules, for execution by computers or other machines. The application 113 may provide graphical user interfaces (GUIs) through which a user may view and interact with other components and devices within the system 100. The GUIs may be formatted, for example, as web pages in HyperText Markup Language (HTML), Extensible Markup Language (XML) or in any other suitable form for presentation on a display device depending upon applications used by users to interact with the system 100.

The merchant device 110 may further include a display 114 and input devices 115. The display 114 may be any type of device for presenting visual information such as a computer monitor, a flat panel display, and a mobile device screen, including liquid crystal displays, light-emitting diode displays, plasma panels, and cathode ray tube displays. The input devices 115 may include any device for entering information into the merchant device 110 that is available and supported by the merchant device 110, such as a touch-screen, keyboard, mouse, cursor-control device, touch-screen, microphone, digital camera, video recorder or camcorder. These devices may be used to enter information and interact with the software and other devices described herein.

The bank device 120 can be used by an entity such as a bank or a financial institute. The bank may issue a contactless card, such as the contactless card 160 for use by users to make purchases from the merchant. The bank device 120 may be configured to present to users a user interface from which the user may log into, for example, their bank or credit card account to access their transaction statement and/or financial information. The bank device 120 may also store transaction history of users, such as purchase history of the users including purchase place, purchase date, purchase time and merchants from which the purchases are made.

The bank device 120 may be a network-enabled computer device. Exemplary network-enabled computer devices include, without limitation, a contactless card, a server, a network appliance, a personal computer, a workstation, a phone, a handheld personal computer, a personal digital assistant, a thin client, a fat client, an Internet browser, a mobile device, a kiosk, a contactless card, or other a computer device or communications device. For example, network-enabled computer devices may include an iPhone, iPod, iPad from Apple® or any other mobile device running Apple's iOS® operating system, any device running Microsoft's Windows® Mobile operating system, any device running Google's Android® operating system, and/or any other smartphone, tablet, or like wearable mobile device.

The bank device 120 may include a processor 121, a memory 122, an application 123, a display 124, and input devices 125. The processor 121 may be a processor, a microprocessor, or other processor, and the bank device 120 may include one or more of these processors. The processor 121 may include processing circuitry, which may contain additional components, including additional processors, memories, error and parity/CRC checkers, data encoders, anti-collision algorithms, controllers, command decoders, security primitives and tamper-proofing hardware, as necessary to perform the functions described herein.

The processor 121 may be coupled to the memory 122. The memory 122 may be a read-only memory, write-once read-multiple memory or read/write memory, e.g., RAM, ROM, and EEPROM, and the bank device 120 may include one or more of these memories. A read-only memory may be factory programmable as read-only or one-time programmable. One-time programmability provides the opportunity to write once then read many times. A write-once read-multiple memory may be programmed at a point in time after the memory chip has left the factory. Once the memory is programmed, it may not be rewritten, but it may be read many times. A read/write memory may be programmed and re-programed many times after leaving the factory. It may also be read many times. The memory 122 may be configured to store one or more software applications, such as the application 123, and other data, such as private and personal information.

The application 123 may comprise one or more software applications comprising instructions for execution on the bank device 120. In some examples, the bank device 120 may execute one or more applications, such as software applications, that, for example, enable network communications with one or more components of the system 100, transmit and/or receive data, and perform the functions described herein. Upon execution by the processor 121, the application 123 may provide the functions described in this specification, specifically to execute and perform the steps and functions in the process flows described herein. Such processes may be implemented in software, such as software modules, for execution by computers or other machines. The application 123 may provide graphic user interfaces (GUIs) through which users may view and interact with other components and devices within the system 100. The GUIs may be formatted, for example, as web pages in HyperText Markup Language (HTML), Extensible Markup Language (XML) or in any other suitable form for presentation on a display device depending upon applications used by users to interact with the system 100.

The bank device 120 may further include a display 124 and input devices 125. The display 124 may be any type of device for presenting visual information such as a computer monitor, a flat panel display, and a mobile device screen, including liquid crystal displays, light-emitting diode displays, plasma panels, and cathode ray tube displays. The input devices 125 may include any device for entering information into the user device 120 that is available and supported by the bank device 120, such as a touch-screen, keyboard, mouse, cursor-control device, touch-screen, microphone, digital camera, video recorder or camcorder. These devices may be used to enter information and interact with the software and other devices described herein such as selecting an option of creating an online account with the merchant.

The server 130 may be associated with an institution, such as a financial institution, and can be configured to communicate with the merchant device 110 and the bank device 120. The institution associated with the server 130 may be the bank associated with the bank device 120, or a central bank authentication entity. The server may be configured to authenticate and/or verify a user based on the contactless card 160 associated with the user. The server 130 may also be configured to receive user risk data from the merchant device 110 and/or the bank device 120.

The server 130 may be a network-enabled computer device. Exemplary network-enabled computer devices include, without limitation, a contactless card, a server, a network appliance, a personal computer, a workstation, a phone, a handheld personal computer, a personal digital assistant, a thin client, a fat client, an Internet browser, a mobile device, a kiosk, a contactless card, or other a computer device or communications device. For example, network-enabled computer devices may include an iPhone, iPod, iPad from Apple® or any other mobile device running Apple's iOS® operating system, any device running Microsoft's Windows® Mobile operating system, any device running Google's Android® operating system, and/or any other smartphone, tablet, or like wearable mobile device.

The server 130 may include a processor 131, a memory 132, and an application 133. The processor 131 may be a processor, a microprocessor, or other processor, and the server 130 may include one or more of these processors. The processor 131 may include processing circuitry, which may contain additional components, including additional processors, memories, error and parity/CRC checkers, data encoders, anti-collision algorithms, controllers, command decoders, security primitives and tamper-proofing hardware, as necessary to perform the functions described herein.

The processor 131 may be coupled to the memory 132. The memory 132 may be a read-only memory, write-once read-multiple memory or read/write memory, e.g., RAM, ROM, and EEPROM, and the server 130 may include one or more of these memories. A read-only memory may be factory programmable as read-only or one-time programmable. One-time programmability provides the opportunity to write once then read many times. A write-once read-multiple memory may be programmed at a point in time after the memory chip has left the factory. Once the memory is programmed, it may not be rewritten, but it may be read many times. A read/write memory may be programmed and re-programed many times after leaving the factory. It may also be read many times. The memory 132 may be configured to store one or more software applications, such as the application 133, and other data, such as user's financial account information and the contactless card information.

The application 133 may comprise one or more software applications, such as a card authentication module, comprising instructions for execution on the server 130. In some examples, the server 130 may execute one or more applications, such as software applications, that, for example, enable network communications with one or more components of the system 100, transmit and/or receive data, and perform the functions described herein. Upon execution by the processor 131, the application 133 may provide the functions described in this specification, specifically to execute and perform the steps and functions in the process flows described herein. For example, a card authentication module of the application 133 may be executed to perform authenticating and/or verifying a user based on the contactless card 160. Such processes may be implemented in software, such as software modules, for execution by computers or other machines. The application 133 may provide GUIs through which a user may view and interact with other components and devices within the system 100. The GUIs may be formatted, for example, as web pages in HyperText Markup Language (HTML), Extensible Markup Language (XML) or in any other suitable form for presentation on a display device depending upon applications used by users to interact with the system 100.

The server 130 may further include a display 134 and input devices 135. The display 134 may be any type of device for presenting visual information such as a computer monitor, a flat panel display, and a mobile device screen, including liquid crystal displays, light-emitting diode displays, plasma panels, and cathode ray tube displays. The input devices 135 may include any device for entering information into the server 130 that is available and supported by the server 130, such as a touch-screen, keyboard, mouse, cursor-control device, touch-screen, microphone, digital camera, video recorder or camcorder. These devices may be used to enter information and interact with the software and other devices described herein.

The database 140 may be one or more databases configured to store date, including without limitation, private information of users, financial accounts of users, contactless card information, online merchant account information, transactions of users, fraud risk data of users, and merchant records indicative of corresponding merchants. The database 140 may comprise a relational database, a non-relational database, or other database implementations, and any combination thereof, including a plurality of relational databases and non-relational databases. In some examples, the database 140 may comprise a desktop database, a mobile database, or an in-memory database. Further, the database 140 may be hosted internally by the server 130 or may be hosted externally of the server 130, such as by a server, by a cloud-based platform, or in any storage device that is in data communication with the server 130.

The system 100 may include one or more networks 150. In some examples, the network 150 may be one or more of a wireless network, a wired network or any combination of wireless network and wired network, and may be configured to connect the merchant device 110, the bank device 120, the server 130, and the database 140. For example, the network 150 may include one or more of a fiber optics network, a passive optical network, a cable network, an Internet network, a satellite network, a wireless local area network (LAN), a Global System for Mobile Communication, a Personal Communication Service, a Personal Area Network, Wireless Application Protocol, Multimedia Messaging Service, Enhanced Messaging Service, Short Message Service, Time Division Multiplexing based systems, Code Division Multiple Access based systems, D-AMPS, Wi-Fi, Fixed Wireless Data, IEEE 802.11b, 802.15.1, 802.11n and 802.11g, Bluetooth, NFC, Radio Frequency Identification (RFID), Wi-Fi, and/or the like.

In addition, the network 150 may include, without limitation, telephone lines, fiber optics, IEEE Ethernet 902.3, a wide area network, a wireless personal area network, a LAN, or a global network such as the Internet. In addition, the network 150 may support an Internet network, a wireless communication network, a cellular network, or the like, or any combination thereof. The network 150 may further include one network, or any number of the exemplary types of networks mentioned above, operating as a stand-alone network or in cooperation with each other. The network 150 may utilize one or more protocols of one or more network elements to which they are communicatively coupled. The network 150 may translate to or from other protocols to one or more protocols of network devices. Although the network 150 is depicted as a single network, it should be appreciated that according to one or more examples, the network 150 may comprise a plurality of interconnected networks, such as, for example, the Internet, a service provider's network, a cable television network, corporate networks, such as credit card association networks, and home networks. The network 150 may further comprise, or be configured to create, one or more front channels, which may be publicly accessible and through which communications may be observable, and one or more secured back channels, which may not be publicly accessible and through which communications may not be observable.

In some examples, communications between the merchant device 110, server 130, and bank device 120 using the network 150 can occur using one or more front channels and one or more secure back channels. A front channel may be a communication protocol that employs a publicly accessible and/or unsecured communication channel such that a communication sent to the merchant device 110, server 130, and/or bank device 120 may originate from any other device, whether known or unknown to the merchant device 110, server 130, and/or bank device 120, if that device possesses the address (e.g., network address, Internet Protocol (IP) address) of the merchant device 110, server 130, and/or bank device 120. Exemplary front channels include, without limitation, the Internet, an open network, and other publicly-accessible communication networks. In some examples, communications sent using a front channel may be subject to unauthorized observation by another device. In some examples, front channel communications may comprise Hypertext Transfer Protocol (HTTP) secure socket layer (SSL) communications, HTTP Secure (HTTPS) communications, and browser-based communications with a server or other device.

A secure back channel may be a communication protocol that employs a secured and/or publicly inaccessible communication channel. A secure back channel communication sent to the merchant device 110, server 130, and/or bank device 120 may not originate from any device, and instead may only originate from a selective number of parties. In some examples, the selective number of devices may comprise known, trusted, or otherwise previously authorized devices. Exemplary secure back channels include, without limitation, a closed network, a private network, a virtual private network, an offline private network, and other private communication networks. In some examples, communications sent using a secure back channel may not be subject to unauthorized observation by another device. In some examples, secure back channel communications may comprise Hypertext Transfer Protocol (HTTP) secure socket layer (SSL) communications, HTTP Secure (HTTPS) communications, and browser-based communications with a server or other device.

The contactless card 160 may be any type of card, such as a security card, a payment card, an identification card, and the like. The contactless card 160 may be issued to a user by the bank for identity verification for the bank account of the user. The contactless card 160 can be used as an universal identifier (ID) of a user for identifying the user across multiple banks, so a social security card number is not needed for identifying the user across the multiple banks, which may enhance data security and user privacy.

The contactless card 160 can be configured to transmit a cryptogram to the bank device 120 or the server upon tapping to a user device or the merchant device 110. The merchant device 110 or the user device may be configured to read the cryptogram from the contactless card 160 after entry of the contactless card 160 into a communication field of the merchant device 110 or the user device. The merchant device 110 or the user device may then transmit the cryptogram to the bank device 120 or the server 130. The server 130 may be configured to verify the cryptogram by searching the database 140.

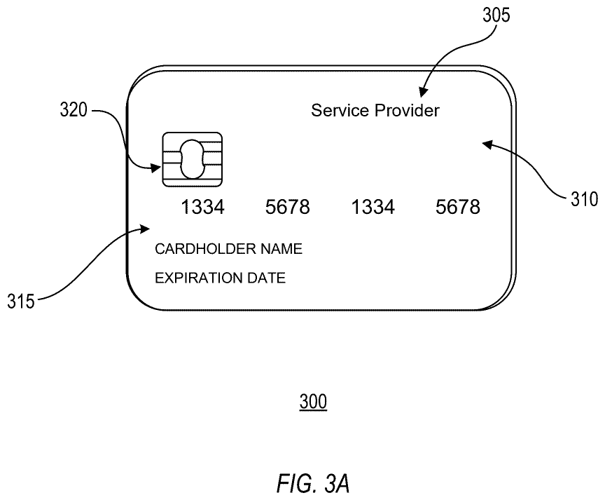

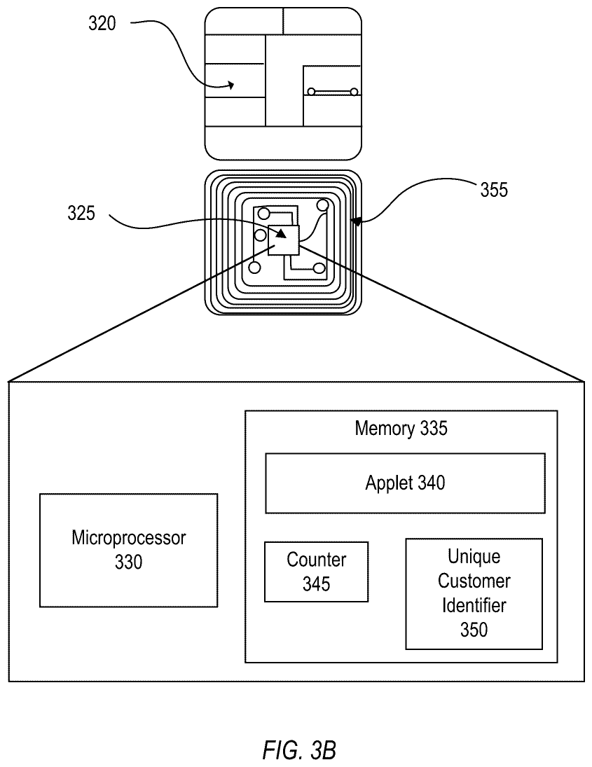

The contactless card 160 can perform authentication and numerous other functions that may otherwise require a user to carry a separate physical token in addition to the contactless card 160. By employing a contactless interface, the contactless card 160 may be provided with a method to interact and communicate between a user's device (such as a mobile phone) and the card itself. For example, the Europay, Mastercard, and Visa (EMV) protocol, which underlies many credit card transactions, includes an authentication process which suffices for operating systems for Android® but presents challenges for iOS®, which is more restrictive regarding near field communication (NFC) usage, as it can be used only in a read-only manner. Exemplary embodiments of the contactless card 160 described herein utilize NFC technology. The contactless card 160 may comprise a substrate 162 and a contact pad 164. Details of an example contactless card will be described in FIGS. 3A and 3B.

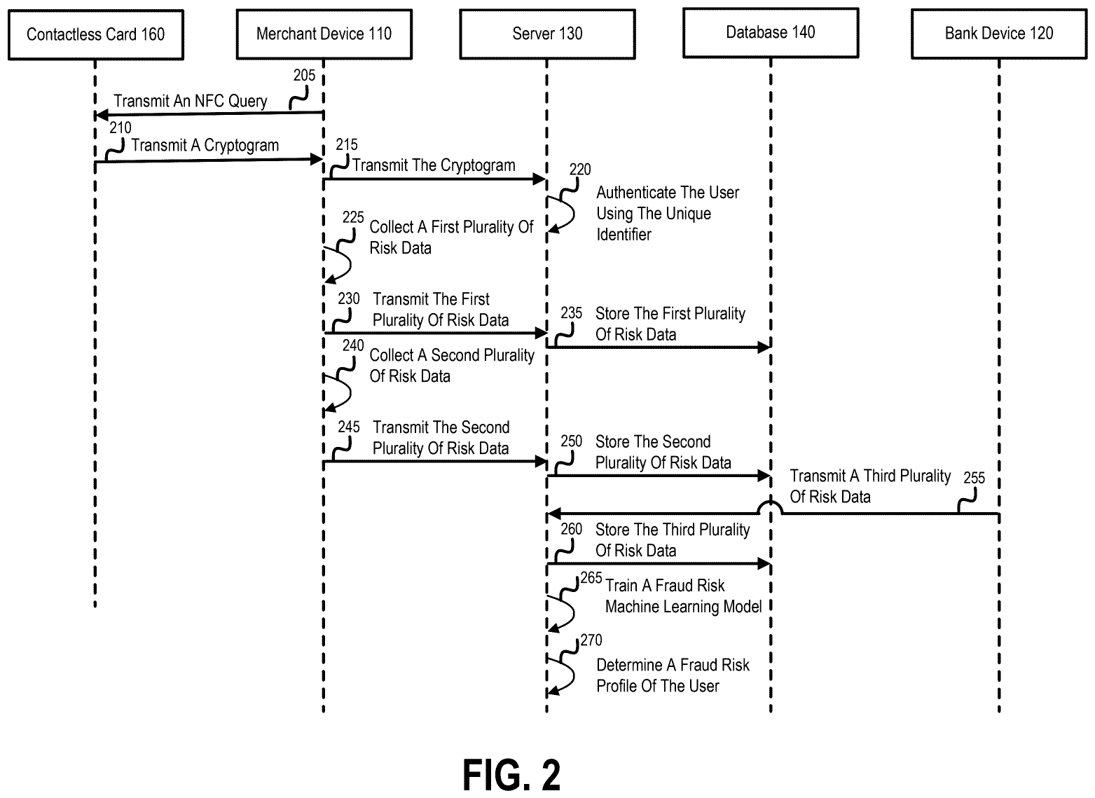

FIG. 2 illustrates an example diagram 200 of sequence interaction between the components of the system 100 according to an example embodiment. FIG. 2 may reference the same or similar components as those illustrated in FIG. 1, including a merchant device, a server, a database, a bank device and a contactless card.

When a user wants to make an online purchase or browse an online website from a merchant, the user may log into his/her website account from a user device of the user, such as a mobile device. In addition, the user may be required to use a contactless card to further authenticate the user. For example, in step 205, the merchant device 110 may transmit a near field communication (NFC) query to the contactless card 160. The application 113 of the merchant device 110 may comprise an application from which the contactless card 160 can be read in that application. The merchant device 110 may be configured to be NFC-enabled and include an NFC interface configured for establishing an NFC communication with other NFC-equipped devices (the contactless card 160 in this embodiment). In some of these embodiments, the NFC interface of the merchant device 110 may be or include an NFC receiver configured for selectively activating a magnetic field for use in establishing near field communication with an NFC transmitter. The NFC interface of the merchant device 110 is configured for establishing NFC communication when a passive NFC tag or other NFC-enabled device is brought into the magnetic field and within the NFC communication range of the merchant device 110. The NFC interface of the merchant device 110 is configured, in particular, for communication with the NFC-enabled contactless card 160 when the contactless card 160 is brought within communication range of the merchant device 110 (such as, the contactless card 160 is tapped by the user to the merchant device 110). As used herein, a tap of the contactless card 160 to the merchant device 110 may indicate that the contactless card 160 is in a physical contact with the merchant device 110 and a tap of the contactless card 160 to the merchant device 110 may refer to entry of the contactless card 160 into the NFC communication field of the merchant device 110.

In response, after entry of the contactless card 160 into the NFC communication field of the merchant device 110, the contactless card 160 transmits, at step 210 to the merchant device 110 NFC response information (e.g., a cryptogram) usable by the server 130 to authenticate the user. The NFC response information may be or include, for example, security information encrypted by the contactless card 160 using a private key unique to the contactless card 160 that is known only to the server 130. The cryptogram may be stored in the memory of the contactless card 160. The cryptogram includes a unique identifier of the contactless card 160, which can be used as an universal identification of the user instead of using a social security card number for identifying the user.

At step 215, the merchant device 110 transmits the NFC response information (the cryptogram) the server 130. At step 220, the server 130 receives the cryptogram from the merchant device 110. The server 130 may validate the cryptogram, decrypt the cryptogram and extract the unique identifier of the contactless card 160 through a card authentication module of the server 130. When the server 130 receives the cryptogram, the server 130 may decrypt the cryptogram after verifying the cryptogram. The server 130 may then extract the unique identifier of the contactless card 160 which is uniquely associated with the user. The server 130 may verify the unique identifier of the contactless card 160 by searching the database 140. The server 130 may authenticate the user based on the unique identifier of the contactless card 160.

In some embodiments, the user may tap the contactless card 160 to a user device of the user. The user device is configured to be an NFC-enabled device and can interact with the contactless card 160. The user device may then transmit a cryptogram generated by the contactless card 160 to the merchant device 110. The merchant device 100 then transmits the cryptogram to the server 130 for authenticating the user using the unique identifier of the contactless card 160. Alternatively, the user device can directly transmit the cryptogram to the server 130 for authenticating the user using the unique identifier of the contactless card 160.

After the user is authenticated and associated with the unique identifier of the contactless card 160. At step 225, the merchant device 110 may collect a first plurality of fraud risk data associated with the user when the user is browsing the website and/or purchasing products and/or services from the website. The first plurality of fraud risk data can include, but is not limited to, one or more of the following in any combination: user behavioral data, for example, whether the user browsing like a typical customer; network connection information, because the user's browser recognizes the user's connection to the website; geolocation of the user; browsing history of the user, for example, including time, location, website contents browsed; mouse movements while the user is browsing the website; the user device's orientation; fonts and language of the website; image data associated with the website; IP address of the user; hardware and software details, for example, user device details, operating system details, web browser details; first and/or third party cookies; autofill data; input logs; browser fingerprints, for example, what websites were visited by the browser; shared same network access information; and/or media access control (MAC) address of the user device. After the first plurality of fraud risk data are collected, in step 230, the merchant device 110 transmits the first plurality of fraud risk data to the server 130. In step 235, the server 130 may store the first plurality of fraud risk data in the database 140.

In step 240, the merchant device 110 may collect a second plurality of fraud risk data associated with the user. A bank with which the user is associated may also have a software development kit (SDK) embedded in the checkout flow of the merchant, such as a contactless card SDK. This SDK can access most of the same data as the merchant but has less visibility into the customers behavior across the browser website.

The second plurality of fraud risk data can include, but is not limited to, one or more of the following in any combination: user behavioral data, for example, whether the user browsing like a typical customer; network connection information, because the user's browser recognizes the user's connection to the website; geolocation of the user; browsing history of the user, for example, including time, location, website contents browsed; mouse movements while the user is browsing the website; the user device's orientation; fonts and language of the website; image data associated with the website; IP address of the user; hardware and software details, for example, user device details, operating system details, web browser details; first and/or third party cookies; autofill data; input logs; browser fingerprints, for example, what websites were visited by the browser; shared same network access information; and/or media access control (MAC) address of the user device. After the second plurality of fraud risk data are collected, in step 245, the merchant device 110 transmits the second plurality of fraud risk data to the server 130. In step 250, the server 130 may store the second plurality of fraud risk data in the database 140.

If the contactless card SDK is used, the contactless card can also provide an identifier (ID) that can be used across banks. This eliminates the need to use personal identification information which can be vulnerable data like social security number (SSN) as a universal identifier.

For the contactless card, since a centralized authentication authority is used, any contactless enabled card from any bank can be used to authenticate transaction from any other bank. A contactless card can be used as a universal hardware authentication token regardless of which bank issued it.

In step 255, participating banks may transmit a third plurality of fraud risk data associated with the user. The banks can also contribute fraud risk data by sending them to the server 130. The third plurality of fraud risk data is contributed around a hashed ID or a universal ID of the user (such as the unique identifier of the contactless card 160) to prevent SSN sharing. This third plurality of fraud risk data is combined with the first plurality of fraud risk data and the second plurality of fraud risk data to create an even better risk profile for the user.

The third plurality of fraud risk data can include, but is not limited to, one or more of the following in any combination: previous transactions of the user at that merchant; recent changes to email or phone number of the user; signs of Account Take Over (ATO) attempts made by a third party on the user's account; and/or recent authentication in the bank application using a contactless card or other methods. As an example, a previous transaction involved a first bank at the merchant may provide enough data to allow a transaction involved a second bank to occur without a multiple factor authentication or even a single factor. In step 260, the server 130 may store the third plurality of fraud risk data in the database 140. Examples of ATO attempts can include: credit card testing-If the bank has detected some small transactions from that merchant previously that might be a sign that the account is compromised, and fraudsters will sometime attempt low value transactions to test if their stolen info is accurate; changes to account data-recent changes to phone numbers, emails or addresses associated with the account; changes to notification settings in bank application, fraudster will try to make sure account holder is not alerted; and on a merchant website it might include multiple failed login attempts recently.

In step 265, the server 130 may train a fraud risk machine learning model using the first plurality of fraud risk, the second plurality of fraud risk, the third plurality of fraud risk, and/or other risk data, such as risk data received previously for the user and/or other users. The machine learning algorithms employed can include at least one selected from the group of gradient boosting machine, logistic regression, neural networks, and a combination thereof, however, it is understood that other machine learning algorithms can be utilized. The fraud risk machine learning model can generate a fraud risk profile of a user indicating a risk level of the user of being a fraudster. The risk level can be on a numerical scale, such as from 1 to 5 with 1 being a lowest risk level and 5 being a highest risk level. The risk level can also be categorized as a low risk level, a medium risk level, and a high risk level.

The fraud risk machine learning model can utilize a Bidirectional Encoder Representations from Transformers (BERT) models. BERT models utilize use multiple layers of so called “attention mechanisms” to process textual data and make predictions. These attention mechanisms effectively allow the BERT model to learn and assign more importance to words from the text input that are more important in making whatever inference is trying to be made.

Alternatively, the fraud risk machine learning model described herein can utilize various neural networks, such as convolutional neural networks (CNNs) or recurrent neural networks (RNNs), to generate the exemplary models. A CNN can include one or more convolutional layers (e.g., often with a subsampling step) and then followed by one or more fully connected layers as in a standard multilayer neural network. CNNs can utilize local connections, and can have tied weights followed by some form of pooling which can result in translation invariant features.

A RNN is a class of artificial neural network where connections between nodes form a directed graph along a sequence. This facilitates the determination of temporal dynamic behavior for a time sequence. Unlike feedforward neural networks, RNNs can use their internal state (e.g., memory) to process sequences of inputs. A RNN can generally refer to two broad classes of networks with a similar general structure, where one is finite impulse and the other is infinite impulse. Both classes of networks exhibit temporal dynamic behavior. A finite impulse recurrent network can be, or can include, a directed acyclic graph that can be unrolled and replaced with a strictly feedforward neural network, while an infinite impulse recurrent network can be, or can include, a directed cyclic graph that cannot be unrolled. Both finite impulse and infinite impulse recurrent networks can have additional stored state, and the storage can be under the direct control of the neural network. The storage can also be replaced by another network or graph, which can incorporate time delays or can have feedback loops. Such controlled states can be referred to as gated state or gated memory, and can be part of long short-term memory networks (“LSTMs”) and gated recurrent units.

RNNs can be similar to a network of neuron-like nodes organized into successive “layers,” each node in a given layer being connected with a directed e.g., (one-way) connection to every other node in the next successive layer. Each node (e.g., neuron) can have a time-varying real-valued activation. Each connection (e.g., synapse) can have a modifiable real-valued weight. Nodes can either be (i) input nodes (e.g., receiving data from outside the network), (ii) output nodes (e.g., yielding results), or (iii) hidden nodes (e.g., that can modify the data en route from input to output). RNNs can accept an input vector x and give an output vector y. However, the output vectors are based not only by the input just provided in, but also on the entire history of inputs that have been provided in in the past.

For supervised learning in discrete time settings, sequences of real-valued input vectors can arrive at the input nodes, one vector at a time. At any given time step, each non-input unit can compute its current activation (e.g., result) as a nonlinear function of the weighted sum of the activations of all units that connect to it. Supervisor-given target activations can be supplied for some output units at certain time steps. For example, if the input sequence is a speech signal corresponding to a spoken digit, the final target output at the end of the sequence can be a label classifying the digit. In reinforcement learning settings, no teacher provides target signals. Instead, a fitness function, or reward function, can be used to evaluate the RNNs performance, which can influence its input stream through output units connected to actuators that can affect the environment. Each sequence can produce an error as the sum of the deviations of all target signals from the corresponding activations computed by the network. For a training set of numerous sequences, the total error can be the sum of the errors of all individual sequences.

The fraud risk machine learning model described herein can be trained on one or more training datasets, each of which can comprise one or more types of data. In some examples, the training datasets can comprise previously-collected data, such as data collected from previous uses of the same type of systems described herein and data collected from different types of systems. In other examples, the training datasets can comprise continuously-collected data based on the current operation of the instant system and continuously-collected data from the operation of other systems. In some examples, the training dataset can include anticipated data, such as the anticipated future events, currently scheduled events, and planned future events, for the instant system and/or other systems. In other examples, the training datasets can include previous predictions for the instant system and other types of system, and can further include results data indicative of the accuracy of the previous predictions. In accordance with these examples, the fraud risk machine learning model described herein can be trained prior to use and the training can continue with updated data sets that reflect additional information.

Examples of fraud risk machine learning model that may be implemented include a hidden Markov model, a Gaussian mixture model, a pattern matching algorithm, a neural network, a matrix representation, (a vector quantization and decision tree, a supervised learning model, an unsupervised learning model, a semi-supervised learning model, a reinforcement learning model, a self-learning model, and a feature learning model.

In step 270, the server 130 determines a fraud risk profile of the user using the fraud risk machine learning model based on the first, second and third pluralities of fraud risk data. As described above, the fraud risk profile of the user can include a fraud risk level associated with the user to indicate how likely the user can or will be a fraudster. The server 130 may share the fraud risk profile of the user among all the participating banks, such that the banks can be aware of the user when the banks conduct transactions with the user.

FIG. 3A describes a contactless card 300 that can be used as an universal identifier for authenticating the user and grouping the first, second and third pluralities of fraud risk data in the system 100 of FIG. 1. For example, the contactless card 160 in FIG. 1 can be the contactless card 300 described herein. The contactless card 300 is configured to communicate with the merchant device 110 and/or a user device of the user of system 100. The contactless card 300 may comprise a payment card, such as a credit card, debit card, or gift card, issued by a service provider 305 (such as a bank associated with the bank device 120) displayed on the front or back of the contactless card 300. In some examples, the contactless card 300 is not related to a payment card, and may comprise, without limitation, an identification card, a membership card, and a transportation card. In some examples, the contactless card 300 may comprise a dual interface contactless payment card.

The contactless card 300 may comprise a substrate 310, which may include a single layer or one or more laminated layers composed of plastics, metals, and other materials. Exemplary substrate materials include polyvinyl chloride, polyvinyl chloride acetate, acrylonitrile butadiene styrene, polycarbonate, polyesters, anodized titanium, palladium, gold, carbon, paper, and biodegradable materials. In some examples, the contactless card 300 may have physical characteristics compliant with the ID-1 format of the ISO/IEC 7810 standard, and the contactless card 300 may otherwise be compliant with the ISO/IEC 14443 standard. However, it is understood that the contactless card 300 according to the present disclosure may have different characteristics, and the present disclosure does not require the contactless card 300 to be implemented in a payment card.

The contactless card 300 may also include identification information 315 displayed on the front and/or back of the contactless card 300, and a contact pad 320. The contact pad 320 may be configured to establish contact with another communication device, such as a user device, smart phone, laptop, desktop, or tablet computer. The contactless card 300 may also include processing circuitry, antenna and other components. These components may be located behind the contact pad 320 or elsewhere on the substrate. The contactless card 300 may also include a magnetic strip or tape, which may be located on the back of the contactless card 300.

FIG. 3B illustrates an example contact pad 320 of the contactless card 300. The contact pad 320 of the contactless card 300 may include processing circuitry 325 for storing and processing information, including a processor 330 and a memory 335. It is understood that the processing circuitry 325 may contain additional components, including processors, memories, error and parity/CRC checkers, data encoders, anticollision algorithms, controllers, command decoders, security primitives and tamperproofing hardware, as necessary to perform the functions described herein.

The memory 335 may be a read-only memory, write-once read-multiple memory or read/write memory, e.g., RAM, ROM, and EEPROM, and the contactless card 300 may include one or more of these memories. A read-only memory may be factory programmable as read-only or one-time programmable. One-time programmability provides the opportunity to write once then read many times. A write once/read-multiple memory may be programmed at a point in time after the memory chip has left the factory. Once the memory is programmed, it may not be rewritten, but it may be read many times. A read/write memory may be programmed and re-programed many times after leaving the factory. It may also be read many times.

In some embodiments, the memory 335 may also have stored public and private card encryption keys. In some embodiments, the private and public encryption keys may be permanently hard-wired into the memory 335. In various embodiments, the memory 335 may have stored therein instructions for generating encrypted information and transmitting it to a receiving device (e.g., the merchant device 110). Such encrypted information may be or include an encrypted verification block or signature that may be used to authenticate and verify the presence of the contactless card 300 during transaction processing. In some embodiments, encrypted information may be unique to a particular communication (e.g., a particular NFC transmission by the contactless card 300).

The memory 335 may be configured to store one or more applets 340, one or more counters 345, and a unique customer identifier 350. The one or more applets 340 may comprise one or more software applications configured to execute on one or more contactless cards, such as Java Card applet. However, it is understood that the one or more applets 340 are not limited to Java Card applets, and instead may be any software application operable on contactless cards or other devices having limited memory. The one or more counters 345 may comprise a numeric counter sufficient to store an integer. The unique customer identifier 350 may comprise a unique alphanumeric identifier assigned to a user of the contactless card 300, and the unique customer identifier 350 may distinguish the user of the contactless card 300 from other contactless card users and therefore can be an universal identifier for the user of that card. In some examples, the customer identifier 350 may identify both a customer and an account assigned to that customer and may further identify the contactless card 300 associated with the customer's account.

The processor 330 and memory 335 elements of the foregoing exemplary embodiments are described with reference to the contact pad 320, but the present disclosure is not limited thereto. It is understood that these elements may be implemented outside of the contact pad 320 or entirely separate from it, or as further elements in addition to the processor 330 and the memory 335 elements located within the contact pad 320.

In some examples, the contactless card 300 may comprise one or more antennas 355. The one or more antennas 355 may be placed within the contactless card 300 and around the processing circuitry 325 of the contact pad 320. For example, the one or more antennas 355 may be integral with the processing circuitry 325 and the one or more antennas 355 may be used with an external booster coil. As another example, the one or more antennas 355 may be external to the contact pad 320 and the processing circuitry 325.

In an embodiment, the coil of contactless card 300 may act as the secondary of an air core transformer. A terminal (such as the merchant device 110 or a user device of the user) may communicate with the contactless card 300 by cutting power or amplitude modulation. The contactless card 300 may infer the data transmitted from the terminal using the gaps in the contactless card's power connection, which may be functionally maintained through one or more capacitors. The contactless card 300 may communicate back by switching a load on the contactless card's coil or load modulation. Load modulation may be detected in the terminal's coil through interference.

As explained above, the contactless card 300 may be built on a software platform operable on smart cards or other devices having limited memory, such as JavaCard, and one or more or more applications or applets (e.g., applet 340) may be securely executed. Applets may be added to contactless cards to provide a one-time password (OTP) for multifactor authentication (MFA) in various mobile application-based use cases. Applets may be configured to respond to one or more requests, such as near field data exchange requests, from a reader, such as a mobile NFC reader, and produce an NDEF message that comprises a cryptographically secure OTP encoded as an NDEF text tag.

The contactless card 300 may be configured for communication with the merchant device 110 or a user device of the user via a communication interface configured for establishing communication with the merchant device 110 or the user device of the user. The communication interface may be configured for contact-based communication, in which case the interface may have electrical circuitry and contact pads on the surface of the contactless card 300 for establishing direct electrical communication between the contactless card 300 and the merchant device 110 or the user device of the user. Alternatively or in addition, the communication interface may be configured for contactless communication with the merchant device 110 or the user device of the user. In such embodiments, the communication interface may be or include an NFC communication interface configured for communication with other NFC communication devices when the contactless card 300 is within a predetermined NFC range. In some embodiments, the contactless card 300 may include a second communication interface configured for establishing short range communication with the merchant device 110 or the user device of the user via Bluetooth, or other short range communication methodology. In such embodiments, the contactless card 300 may have a short range communication antenna that is included in or connected to the short range communication interface. The contactless card 300 may also include a power management system for use in managing the distribution of power during an NFC transaction.

The contactless card 300 can be configured to transmit a cryptogram to the merchant device 110 or the user device of the user upon tapping to the merchant device 110 or the user device of the user, respectively. The merchant device 110 or the user device of the user may be configured to read the cryptogram from the contactless card 300 after entry of the contactless card 300 into a communication field of the merchant device 110 or the user device of the user. The merchant device 110 or the user device of the user may then transmit the cryptogram to the server 130. The server 130 may be configured to verify the cryptogram by searching the database 140.

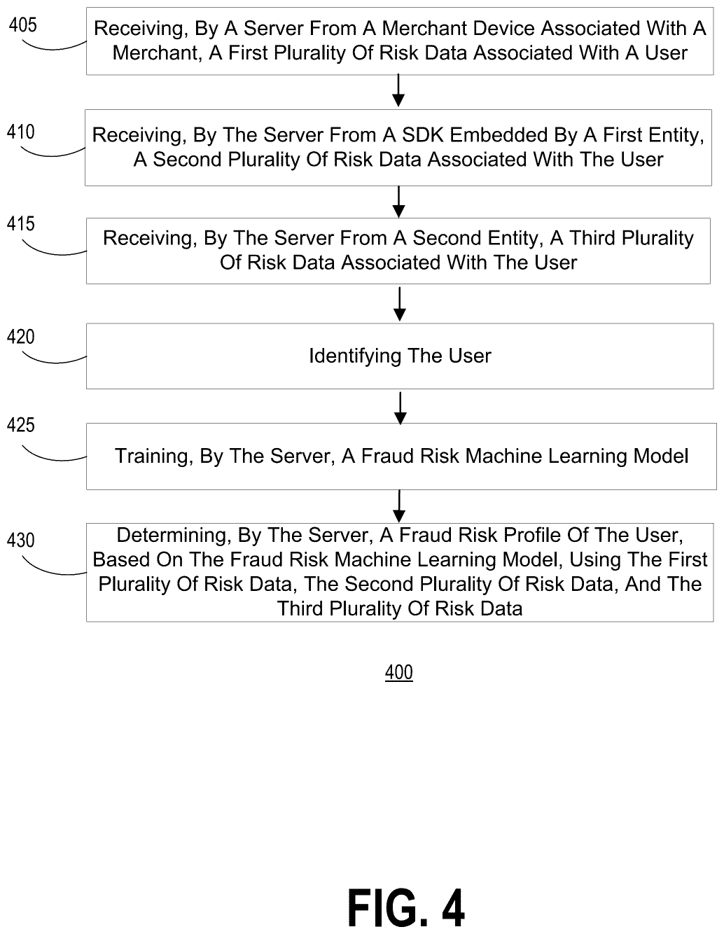

FIG. 4 illustrates a flow chart of an example method 400 for reducing fraud according to an example embodiment. FIG. 4 may reference the same or similar components as those illustrated in FIGS. 1-3, including a merchant device and/or a user device, a server, a database, a bank device, and a contactless card. The method 400 can be implemented in the system 100 and may include, but is not limited to the following steps.

As described above, when a user wants to make an online purchase or browse an online website from a merchant, the user may log into his/her website account from a user device of the user, such as a mobile device, or from the merchant device 110. The merchant device 110 may collect a first plurality of fraud risk data associated with the user when the user is browsing the website and/or purchasing products/services from the website. The first plurality of fraud risk data can include, but is not limited to, one or more of the following in any combination: user behavioral data, for example, whether the user browsing like a typical customer; network connection information, because the user's browser recognizes the user's connection to the website; geolocation of the user; browsing history of the user, for example, including time, location, website contents browsed; mouse movements while the user is browsing the website; the user device's orientation; fonts and language of the website; image data associated with the website; IP address of the user; hardware and software details, for example, user device details, operating system details, web browser details; first and/or third party cookies; autofill data; input logs; browser fingerprints, for example, what websites were visited by the browser; shared same network access information; and/or media access control (MAC) address of the user device. After the first plurality of fraud risk data are collected, in step 230, the merchant device 110 transmits the first plurality of fraud risk data to the server 130. In step 235, the server 130 may store the first plurality of fraud risk data in the database 140. The merchant device 110 may transmit the first plurality of fraud risk data to the server 130. Accordingly, in step 405, the server 130 receives from the merchant device 110 associated with the merchant, the first plurality of risk data associated with the user.

A bank may have a SDK embedded in the checkout flow of the merchant, such as a contactless card SDK. This SDK can access most of the same data as the merchant, but has less visibility into the customers behavior across the browser website. The merchant device 110 may collect a second plurality of fraud risk data associated with the user through the SDK.

The second plurality of fraud risk data can include, but is not limited to, one or more of the following in any combination: user behavioral data, for example, whether the user browsing like a typical customer; network connection information, because the user's browser recognizes the user's connection to the website; geolocation of the user; browsing history of the user, for example, including time, location, website contents browsed; mouse movements while the user is browsing the website; the user device's orientation; fonts and language of the website; image data associated with the website; IP address of the user; hardware and software details, for example, user device details, operating system details, web browser details; first and/or third party cookies; autofill data; input logs; browser fingerprints, for example, what websites were visited by the browser; shared same network access information; and/or media access control (MAC) address of the user device. After the second plurality of fraud risk data are collected, the merchant device 110 transmits the second plurality of fraud risk data to the server 130. Accordingly, in step 410, the server 130 receives from the SDK, the second plurality of fraud risk data associated with the user.

Participating banks as other entities may transmit a third plurality of fraud risk data associated with the user to the server 130. The banks can also contribute fraud risk data by sending them to the server 130. The third plurality of fraud risk data can include, but is not limited to, one or more of the following in any combination: previous transactions of the user at that merchant; recent changes to email or phone number of the user; signs of Account Take Over (ATO) attempts made by a third party on the user's account; and/or recent authentication in the bank application using a contactless card or other methods. As an example, a previous transaction involved a first bank at the merchant may provide enough data to allow a transaction involved a second bank to occur without a multiple factor authentication or even a single factor. Accordingly, in step 415, the server 130 receives, from one or more of the participating banks, the third plurality of risk data associated with the user. Examples of ATO attempts can include: credit card testing-If the bank has detected some small transactions from that merchant previously that might be a sign that the account is compromised, and fraudsters will sometime attempt low value transactions to test if their stolen info is accurate; changes to account data-recent changes to phone numbers, emails or addresses associated with the account; changes to notification settings in bank application, fraudster will try to make sure account holder is not alerted; and on a merchant website it might include multiple failed login attempts recently

To further verify the user and categorize the received first, second, and third plurality of fraud risk data, the server 130 may request the user to tap a contactless card (e.g., the contactless card 160) issued by a participating bank. The unique identifier of the contactless card can be an universal ID of the user for the server to identifying the user in step 420. Based on the universal ID, the first, second and third pluralities of fraud risk data can be grouped and combined around the user.

In step 425, the server 130 may train a fraud risk machine learning model using the first plurality of fraud risk, the second plurality of fraud risk, the third plurality of fraud risk, and/or other risk data, such as risk data received previously for the user and/or other users. The machine learning algorithms employed can include at least one selected from the group of gradient boosting machine, logistic regression, neural networks, and a combination thereof, however, it is understood that other machine learning algorithms can be utilized. The fraud risk machine learning model can generate a fraud risk profile of a user indicating a risk level of the user of being a fraudster. The risk level can be on a numerical scale, such as from 1 to 5 with 1 being a lowest risk level and 5 being a highest risk level. The risk level can also be categorized as a low risk level, a medium risk level, and a high risk level.

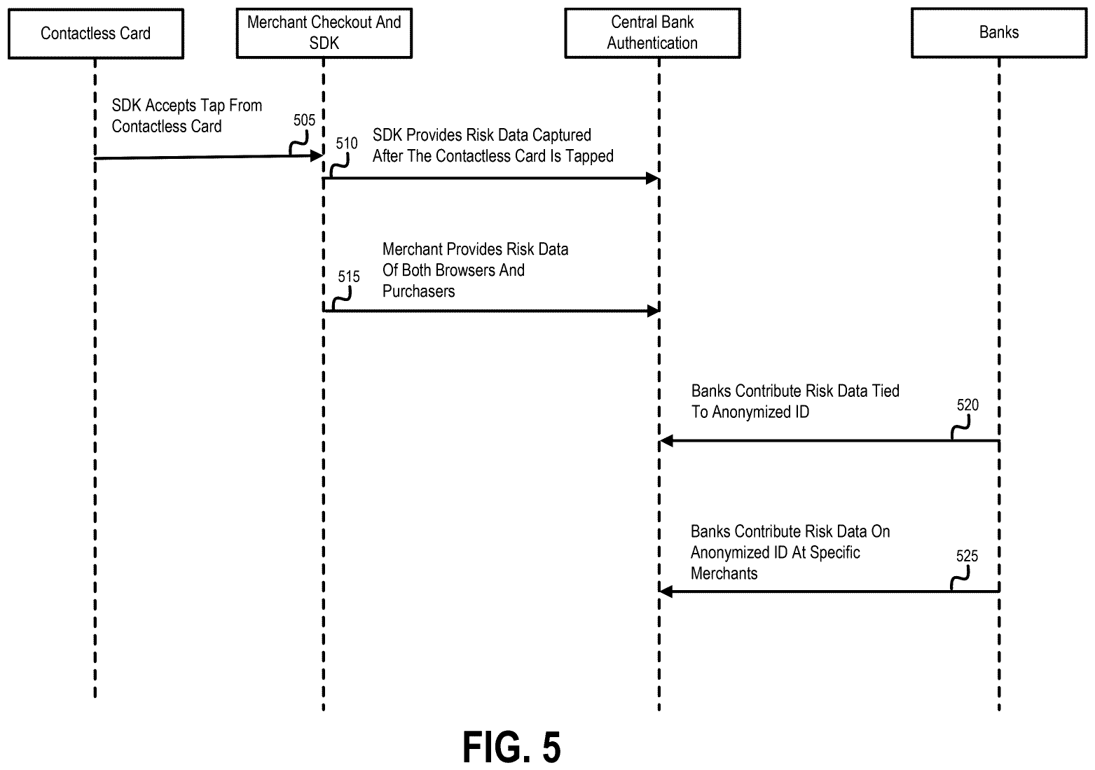

In step 430, the server 130 determines a fraud risk profile of the user, based on the fraud risk machine learning model, using the first plurality of risk data, the second plurality of risk data, and the third plurality of risk data. The fraud risk profile of the user can include a fraud risk level associated with the user to indicate how likely the user can or will be a fraudster. The server 130 may share the fraud risk profile of the user among all the participating banks, such that the banks can be aware of the user when the banks conduct transactions with the user.

[FIG. 5 Describes Another System Diagram Provided by Inventors that Include Merchant, Central Authority, and Banks.]

FIG. 5 illustrates a diagram of sequential interactions between components of a system 500 for reducing fraud according to an example embodiment. The diagram of system 500 may include a contact less card, a merchant checkout program and SDK, a central authentication, and multiple banks. The sequential interactions between components of the system 500 can include, but are not limited to the following steps.

In step 505, the SDK can accept a tap from a contactless card from any bank, and is not limited to a specific bank. The contactless card ID can be used as an universal identifier. The SDK can be a contactless card SDK, which can collect a plurality of fraud risk data. The plurality of fraud risk data can comprise data captured by the SDK after the contactless card is tapped that links the risk data to a specific bank customer.

In step 510, the SDK can provide the plurality of risk data to the central bank authentication.

In step 515, the merchant, through a merchant checkout flow, collect a plurality of fraud risk data. The plurality of fraud risk data can comprise risk data of browsers and purchasers who either browse the website of the merchant or make purchases from the website of the merchant. The plurality of fraud risk data can be transmitted to the central bank authentication.

In step 520, the banks can also contribute risk data into the central authentication, which may comprise risk data on customers tied to their anonymized card ID. In step 525 the banks may also contribute risk data on anonymized ID spending at specific merchants. With different banks contributing their risk data to the central authentication, it can facilitate to determine a customer who is actively engaged on a specific device is a real customer, as opposed to somebody else coming on through.

If a customer does not finish a transaction but the customer is interacting with the merchant website or interacting with the SDK, the risk data of the customer can be collected and transmitted back to the central authentication. Upon a contactless card is tapped, the customer can be more clearly identified as who they are, and can be further enhanced, for example through an one-time-password (OTP) or any other form of authentication. Once the customer is clearly identified, the collected data is more directly tied to that customer. If the customer is just wondering around the website and has not been identified previously, that collected data may not be as valuable until after the customer taps his/her card, then potentially the data collected prior to the tap can also be applied to that customer. The SDK can read risk data during the checkout flow to identify the device binding to that customer.

The risk data collected by banks can include, for example, the last time a customer authenticated through a short message service (SMS) OTP or tapping a contactless card within the bank application, or the last time the customer approves an information check (e.g., a phone company indicates that this customer has their identity checked on a certain date and that there was not a subscriber identity module (SIM) card swap on the customer's account).

Provisioning the contactless card to the merchant can be done by the central authority or by the banks. In a case where the provisioning is conducted by the central authority, a bank would provide that card information through the central authority. For example, banks can provide to the central authentication the unique identifier of each contactless card they issued to that customer, and the central authentication can associate the unique identifiers with that customer.

The risk data collected can be stored in a database associated with the central authentication. In some embodiments, the risk data collected by a particular bank may be stored in a datastore associated with that particular bank, and the central authentication can retrieve that data on demand or in real time (e.g., when a transaction occurs) from that bank and determine a fraud risk profile of the user.

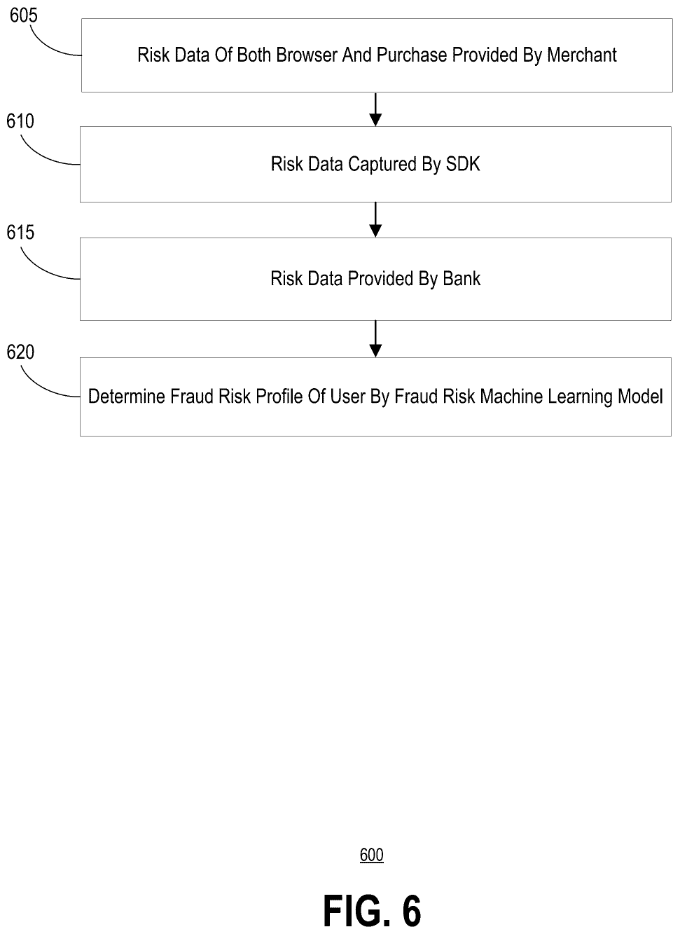

FIG. 6 describes a flow chart of a method 600 of determining a fraud risk file for a user using a fraud risk machine learning model according to an example embodiment. FIG. 6 may reference the same or similar components as those illustrated in FIGS. 1-5, including a merchant device, a server, a database, a bank device, and a contactless card. The method 600 can be implemented in the system 100 and/or 500 and may include, but is not limited to, the following steps.

In step 605, the server receives risk data of both browsers and purchasers provided by the merchant. For example, the merchant collects risk data of both the browsers and purchasers that are interacting with the website of the merchant and transmits the collected data to the server. The risk data can include, but is not limited to, one or more of the following in any combination: behavioral data of both browsers and purchasers, for example, whether the browsers and purchasers browsing like a typical customer; network connection information, because the browsers and purchasers browser recognizes their connection to the website; geolocation of the browsers and purchasers; browsing history of the browsers and purchasers, for example, including time, location, website contents browsed; mouse movements while the browsers and purchasers are browsing the website; the browsers and purchasers device's orientation; fonts and language of the website; image data associated with the website; IP address of the browsers and purchasers; hardware and software details, for example, user device details, operating system details, web browser details; first and/or third party cookies; autofill data; input logs; browser fingerprints, for example, what websites were visited by the browser; shared same network access information; and/or media access control (MAC) address of the user device.

In step 610, the server receives risk data captured by an SDK. As described above, the SDK can be a contactless card SDK embedded in the website of the merchant by either the bank issuing the contactless card or the central authority that receives the provisioning information of the contactless card from that bank. This SDK can access most of the same data as the merchant, but has less visibility into the customers behavior across the browser website. The risk data captured by the SDK can include, but is not limited to, one or more of the following in any combination: behavioral data of both browsers and purchasers, for example, whether the browsers and purchasers browsing like a typical customer; network connection information, because the browsers and purchasers browser recognizes their connection to the website; geolocation of the browsers and purchasers; browsing history of the browsers and purchasers, for example, including time, location, website contents browsed; mouse movements while the browsers and purchasers are browsing the website; the browsers and purchasers device's orientation; fonts and language of the website; image data associated with the website; IP address of the browsers and purchasers; hardware and software details, for example, user device details, operating system details, web browser details; first and/or third party cookies; autofill data; input logs; browser fingerprints, for example, what websites were visited by the browser; shared same network access information; and/or media access control (MAC) address of the user device.

In step 615, the server receives risk data provided by participating banks. As described above, the risk data provided by the participating banks can include transaction history of the user. The risk data provided by the participating banks can include, but is not limited to, one or more of the following in any combination: previous transactions of the browsers and purchasers at that merchant; recent changes to email or phone number of the browsers and purchasers; signs of Account Take Over (ATO) attempts made by a third party on the browsers and purchasers account; and/or recent authentication in the bank application using a contactless card or other methods. As an example, a previous transaction involved a first bank at the merchant may provide enough data to allow a transaction involved a second bank to occur without a multiple factor authentication or even a single factor. Examples of ATO attempts can include: credit card testing-If the bank has detected some small transactions from that merchant previously that might be a sign that the account is compromised, and fraudsters will sometime attempt low value transactions to test if their stolen info is accurate; changes to account data-recent changes to phone numbers, emails or addresses associated with the account; changes to notification settings in bank application, fraudster will try to make sure account holder is not alerted; and on a merchant website it might include multiple failed login attempts recently

In step 620, the server determines a fraud risk profile of the user by the fraud risk machine learning model using the risk data received above. The fraud risk machine learning model can include supervised machine learning model, unsupervised machine learning model, and so forth. The fraud risk profile of the user can include a fraud risk level associated with the user to indicate how likely the user can or will be a fraudster. The server 130 may share the fraud risk profile of the user among all the participating banks, such that the banks can be aware of the user when the banks conduct transactions with the user.

In some aspects, the techniques described herein relate to a method for reducing fraud, including: receiving, by a server from a merchant device associated with a merchant, a first plurality of risk data associated with a user; receiving, by the server from a software development kit (SDK) embedded by a first entity, a second plurality of risk data associated with the user; receiving, by the server from a second entity, a third plurality of risk data associated with the user; identifying the user; training, by the server, a fraud risk machine learning model; and determining, by the server, a fraud risk profile of the user, based on the fraud risk machine learning model, using the first plurality of risk data, the second plurality of risk data, and the third plurality of risk data.

In some aspects, the techniques described herein relate to a method, wherein the SDK is embedded in a checkout flow of the merchant.

In some aspects, the techniques described herein relate to a method, wherein the third plurality of risk data includes fraud data.

In some aspects, the techniques described herein relate to a method, wherein the first plurality of risk data is obtained by the merchant during a checkout flow of the merchant.

In some aspects, the techniques described herein relate to a method, wherein the first plurality of risk data includes website browsing data of a website of the merchant that is browsed by the user.

In some aspects, the techniques described herein relate to a method, wherein the website browsing data includes at least one selected from the group of behavioral data, browser connection data, geolocation data, browsing history data, mouse movement data, device orientation data, fronts and languages data, image data, Internet Protocol (IP) address data, hardware details data, software details data, first party cookies, third party cookies, autofill data, detailed input logs data, browser fingerprints data, shared WIFI data, and Media Access Control (MAC) address data.

In some aspects, the techniques described herein relate to a method, wherein the third plurality of risk data is associated with the user through an universal identifier.

In some aspects, the techniques described herein relate to a method, wherein the universal identifier is a social security number of the user.

In some aspects, the techniques described herein relate to a method, wherein the universal identifier is a card identifier of the user.

In some aspects, the techniques described herein relate to a method, further including receiving from a third entity, a fourth plurality of risk data associated with the user.

In some aspects, the techniques described herein relate to a method, wherein the user is identified through the universal identifier.

In some aspects, the techniques described herein relate to a method, wherein the third plurality of risk data includes the time and date of the most recent Short Message Service (SMS) one time password (OTP) authentication completed by the user.

In some aspects, the techniques described herein relate to a system for reducing fraud, including: a server including a processor and a memory, wherein the server is configured to: receive, from a merchant device associated with a merchant, a first plurality of risk data associated with a user; receive, from a software development kit (SDK) embedded by a first entity, a second plurality of risk data associated with the user; receive, from a second entity, a third plurality of risk data associated with the user; identify the user; train a fraud risk machine learning model; and determine a fraud risk profile of the user, based on the fraud risk machine learning model, using the first plurality of risk data, the second plurality of risk data, and the third plurality of risk data.

In some aspects, the techniques described herein relate to a system, wherein the first plurality of risk data includes website browsing data of a website of the merchant that is browsed by the user, and the website browsing data includes at least one selected from the group of behavioral data, browser connection data, geolocation data, browsing history data, mouse movement data, device orientation data, fronts and languages data, image data, and Internet Protocol (IP) address data.

In some aspects, the techniques described herein relate to a system, wherein the third plurality of risk data is associated with the user through an universal identifier, and the universal identifier is a card identifier of the user.

In some aspects, the techniques described herein relate to a system, wherein the first plurality of risk data includes website browsing data of a website of the merchant that is browsed by the user, and the website browsing data includes at least one selected from the group of hardware details data, software details data, first party cookies, third party cookies, autofill data, detailed input logs data.

In some aspects, the techniques described herein relate to a system, wherein the third plurality of risk data is associated with the user through an universal identifier, and the server is further configured to receive from a third entity, a fourth plurality of risk data associated with the user.

In some aspects, the techniques described herein relate to a system, wherein the third plurality of risk data is associated with the user through an universal identifier, and the user is identified through the universal identifier.

In some aspects, the techniques described herein relate to a system, wherein the first plurality of risk data includes website browsing data of a website of the merchant that is browsed by the user, and the website browsing data includes at least one selected from the group of browser fingerprints data, shared network data, and Media Access Control (MAC) address data.

In some aspects, the techniques described herein relate to a non-transitory, computer-readable medium including instructions for reducing fraud that, when executed on a computer arrangement, perform actions including: receiving, from a merchant device associated with a merchant, a first plurality of risk data associated with a user; receiving, from a software development kit (SDK) embedded by a first entity, a second plurality of risk data associated with the user; receiving, from a second entity, a third plurality of risk data associated with the user; identifying the user; training a fraud risk machine learning model; and determining a fraud risk profile of the user, based on the fraud risk machine learning model, using the first plurality of risk data, the second plurality of risk data, and the third plurality of risk data.

As used herein, the term “bank” is not limited to a particular bank or type of bank. Rather, it is understood that the present disclosure includes any type of bank or other business involved in activities where products or services are sold or otherwise provided.

As used herein, the term “merchant” is not limited to a particular merchant or type of merchant. Rather, it is understood that the present disclosure includes any type of merchant, vendor, or other entity involved in activities where products or services are sold or otherwise provided.

As used herein, the term “account” is not limited to a particular type of account. Rather, it is understood that the term “account” can refer to a variety of accounts, including without limitation, a financial account (e.g., a credit account, a debit account), a membership account, a loyalty account, a subscription account, a services account, a utilities account, a transportation account, and a physical access account. It is further understood that the present disclosure is not limited to accounts issued by a particular entity.

As used herein, the term “card” is not limited to a particular type of card. Rather, it is understood that the term “card” can refer to a contact-based card, a contactless card, or any other card, unless otherwise indicated. It is further understood that the present disclosure is not limited to cards having a certain purpose (e.g., payment cards, gift cards, identification cards, membership cards, transportation cards, access cards), to cards associated with a particular type of account (e.g., a credit account, a debit account, a membership account), or to cards issued by a particular entity (e.g., a commercial entity, a financial institution, a government entity, a social club). Instead, it is understood that the present disclosure includes cards having any purpose, account association, or issuing entity.

In some examples, exemplary procedures in accordance with the present disclosure described herein can be performed by a processing arrangement and/or a computing arrangement (e.g., a computer hardware arrangement). Such processing and/or computing arrangement can be, for example entirely or a part of, or include, but not limited to, a computer/processor that can include, for example one or more microprocessors, and use instructions stored on a computer-accessible medium (e.g., RAM, ROM, hard drive, or other storage device). For example, a computer-accessible medium can be part of the memory of a first device, a user device, a server, or other computer hardware arrangement.

In some examples, a computer-accessible medium (e.g., as described herein above, a storage device such as a hard disk, floppy disk, memory stick, CD-ROM, RAM, ROM, etc., or a collection thereof) can be provided (e.g., in communication with the processing arrangement). The computer-accessible medium can contain executable instructions thereon. In addition or alternatively, a storage arrangement can be provided separately from the computer-accessible medium, which can provide the instructions to the processing arrangement so as to configure the processing arrangement to execute certain exemplary procedures, processes, and methods, as described herein above, for example.

It is further noted that the systems and methods described herein may be tangibly embodied in one or more physical media, such as, but not limited to, a compact disc (CD), a digital versatile disc (DVD), a floppy disk, a hard drive, read only memory (ROM), random access memory (RAM), as well as other physical media capable of data storage. For example, data storage may include random access memory (RAM) and read only memory (ROM), which may be configured to access and store data and information and computer program instructions. Data storage may also include storage media or other suitable type of memory (e.g., such as, for example, RAM, ROM, programmable read-only memory (PROM), erasable programmable read-only memory (EPROM), electrically erasable programmable read-only memory (EEPROM), magnetic disks, optical disks, floppy disks, hard disks, removable cartridges, flash drives, and any type of tangible and non-transitory storage medium), where the files that comprise an operating system, application programs including, for example, web browser application, email application and/or other applications, and data files may be stored. The data storage of the network-enabled computer systems may include electronic information, files, and documents stored in various ways, including, for example, a flat file, indexed file, hierarchical database, relational database, such as a database created and maintained with software from, for example, Oracle® Corporation, Microsoft® Excel file, Microsoft® Access file, a solid state storage device, which may include a flash array, a hybrid array, or a server-side product, enterprise storage, which may include online or cloud storage, or any other storage mechanism. Moreover, the figures illustrate various components (e.g., servers, computers, processors, etc.) separately. The functions described as being performed at various components may be performed at other components, and the various components may be combined or separated. Other modifications also may be made.

Computer readable program instructions described herein can be downloaded to respective computing and/or processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing and/or processing device receives computer readable program instructions from the network and forwards the computer readable program instructions for storage in a computer readable storage medium within the respective computing and/or processing device.

Computer readable program instructions for carrying out operations of the present invention may be assembler instructions, instruction-set-architecture (ISA) instructions, machine instructions, machine dependent instructions, microcode, firmware instructions, state-setting data, or either source code or object code written in any combination of one or more programming languages, including an object oriented programming language such as Java, Smalltalk, C++ or the like, and conventional procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, to perform aspects of the present invention.

These computer readable program instructions may be provided to a processor of a general-purpose computer, special purpose computer, or other programmable data processing apparatus to produce a machine, such that the instructions, which execute via the processor of the computer or other programmable data processing apparatus, create means for implementing the functions specified herein. These computer-readable program instructions may also be stored in a computer-readable storage medium that can direct a computer, a programmable data processing apparatus, and/or other devices to function in a manner, such that the computer readable storage medium having instructions stored therein comprises an article of manufacture including instructions which implement aspects of the functions specified herein.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions specified herein.

Implementations of the various techniques described herein may be implemented in digital electronic circuitry, or in computer hardware, firmware, software, or in combinations of them. Implementations may be implemented as a computer program product, i.e., a computer program tangibly embodied in an information carrier, e.g., in a machine readable storage device or in a propagated signal, for execution by, or to control the operation of, data processing apparatus, e.g., a programmable processor, a computer, or multiple computers. A computer program, such as the computer program(s) described above, can be written in any form of programming language, including compiled or interpreted languages, and can be deployed in any form, including as a stand-alone program or as a module, component, subroutine, or other unit suitable for use in a computing environment. A computer program can be deployed to be executed on one computer or on multiple computers at one site or distributed across multiple sites and interconnected by a communication network.

Method steps may be performed by one or more programmable processors executing a computer program to perform functions by operating on input data and generating output. Method steps also may be performed by, and an apparatus may be implemented as, special purpose logic circuitry, e.g., an FPGA (field programmable gate array) or an ASIC (application specific integrated circuit).

Throughout the disclosure, the following terms take at least the meanings explicitly associated herein, unless the context clearly dictates otherwise. The term “or” is intended to mean an inclusive “or.” Further, the terms “a,” “an,” and “the” are intended to mean one or more unless specified otherwise or clear from the context to be directed to a singular form.

In this description, numerous specific details have been set forth. It is to be understood, however, that implementations of the disclosed technology may be practiced without these specific details. In other instances, well-known methods, structures and techniques have not been shown in detail in order not to obscure an understanding of this description. References to “some examples,” “other examples,” “one example,” “an example,” “various examples,” “one embodiment,” “an embodiment,” “some embodiments,” “example embodiment,” “various embodiments,” “one implementation,” “an implementation,” “example implementation,” “various implementations,” “some implementations,” etc., indicate that the implementation(s) of the disclosed technology so described may include a particular feature, structure, or characteristic, but not every implementation necessarily includes the particular feature, structure, or characteristic. Further, repeated use of the phrases “in one example,” “in one embodiment,” or “in one implementation” does not necessarily refer to the same example, embodiment, or implementation, although it may.

As used herein, unless otherwise specified the use of the ordinal adjectives “first,” “second,” “third,” etc., to describe a common object, merely indicate that different instances of like objects are being referred to, and are not intended to imply that the objects so described must be in a given sequence, either temporally, spatially, in ranking, or in any other manner.

While certain implementations of the disclosed technology have been described in connection with what is presently considered to be the most practical and various implementations, it is to be understood that the disclosed technology is not to be limited to the disclosed implementations, but on the contrary, is intended to cover various modifications and equivalent arrangements included within the scope of the appended claims. Although specific terms are employed herein, they are used in a generic and descriptive sense only and not for purposes of limitation.

This written description uses examples to disclose certain implementations of the disclosed technology, including the best mode, and also to enable any person skilled in the art to practice certain implementations of the disclosed technology, including making and using any devices or systems and performing any incorporated methods. The patentable scope of certain implementations of the disclosed technology is defined in the claims, and may include other examples that occur to those skilled in the art. Such other examples are intended to be within the scope of the claims if they have structural elements that do not differ from the literal language of the claims, or if they include equivalent structural elements with insubstantial differences from the literal language of the claims.

What is claimed is:

1. A method for reducing fraud, comprising:
receiving, by a server from a merchant device associated with a merchant, a first plurality of risk data associated with a user;
receiving, by the server from a software development kit (SDK) embedded by a first entity, a second plurality of risk data associated with the user;
receiving, by the server from a second entity, a third plurality of risk data associated with the user;
identifying the user;
training, by the server, a fraud risk machine learning model; and
determining, by the server, a fraud risk profile of the user, based on the fraud risk machine learning model, using the first plurality of risk data, the second plurality of risk data, and the third plurality of risk data.

2. The method according to claim 1, wherein the SDK is embedded in a checkout flow of the merchant.

3. The method according to claim 1, wherein the third plurality of risk data includes fraud data.

4. The method according to claim 1, wherein the first plurality of risk data is obtained by the merchant during a checkout flow of the merchant.

5. The method according to claim 1, wherein the first plurality of risk data includes website browsing data of a website of the merchant that is browsed by the user.

6. The method according to claim 5, wherein the website browsing data includes at least one selected from the group of behavioral data, browser connection data, geolocation data, browsing history data, mouse movement data, device orientation data, fronts and languages data, image data, Internet Protocol (IP) address data, hardware details data, software details data, first party cookies, third party cookies, autofill data, detailed input logs data, browser fingerprints data, shared WIFI data, and Media Access Control (MAC) address data.

7. The method according to claim 1, wherein the third plurality of risk data is associated with the user through an universal identifier.

8. The method according to claim 7, wherein the universal identifier is a social security number of the user.

9. The method according to claim 7, wherein the universal identifier is a card identifier of the user.

10. The method according to claim 7, further comprising receiving from a third entity, a fourth plurality of risk data associated with the user.

11. The method according to claim 7, wherein the user is identified through the universal identifier.

12. The method according to claim 1, wherein the third plurality of risk data includes the time and date of the most recent Short Message Service (SMS) one time password (OTP) authentication completed by the user.

13. A system for reducing fraud, comprising:
a server comprising a processor and a memory,
wherein the server is configured to:
receive, from a merchant device associated with a merchant, a first plurality of risk data associated with a user;
receive, from a software development kit (SDK) embedded by a first entity, a second plurality of risk data associated with the user;
receive, from a second entity, a third plurality of risk data associated with the user;
identify the user;
train a fraud risk machine learning model; and
determine a fraud risk profile of the user, based on the fraud risk machine learning model, using the first plurality of risk data, the second plurality of risk data, and the third plurality of risk data.

14. The system according to claim 13, wherein the first plurality of risk data includes website browsing data of a website of the merchant that is browsed by the user, and the website browsing data includes at least one selected from the group of behavioral data, browser connection data, geolocation data, browsing history data, mouse movement data, device orientation data, fronts and languages data, image data, and Internet Protocol (IP) address data.

15. The system according to claim 13, wherein the third plurality of risk data is associated with the user through a universal identifier, and the universal identifier is a card identifier of the user.

16. The system according to claim 13, wherein the first plurality of risk data includes website browsing data of a website of the merchant that is browsed by the user, and the website browsing data includes at least one selected from the group of hardware details data, software details data, first party cookies, third party cookies, autofill data, detailed input logs data.

17. The system according to claim 13, wherein the third plurality of risk data is associated with the user through a universal identifier, and the server is further configured to receive from a third entity, a fourth plurality of risk data associated with the user.

18. The system according to claim 13, wherein the third plurality of risk data is associated with the user through an universal identifier, and the user is identified through the universal identifier.

19. The system according to claim 13, wherein the first plurality of risk data includes website browsing data of a website of the merchant that is browsed by the user, and the website browsing data includes at least one selected from the group of browser fingerprint data, shared network data, and Media Access Control (MAC) address data.

20. A non-transitory, computer-readable medium comprising instructions for reducing fraud that, when executed on a computer arrangement, perform actions comprising:
receiving, from a merchant device associated with a merchant, a first plurality of risk data associated with a user;
receiving, from a software development kit (SDK) embedded by a first entity, a second plurality of risk data associated with the user;
receiving, from a second entity, a third plurality of risk data associated with the user;
identifying the user;
training a fraud risk machine learning model; and
determining a fraud risk profile of the user, based on the fraud risk machine learning model, using the first plurality of risk data, the second plurality of risk data, and the third plurality of risk data.
